(19) United States
(12) Patent Application Publication
(10) Pub. No.: US 2019/0126387 A1
(43) Pub. Date: May 2, 2019

(54) DEVICE AND METHOD FOR PRODUCING METALLIC COMPONENTS

(71) Applicants: FRAUNHOFER-GESELLSCHAFT ZUR FOERDERUNG DER ANGEWANDTEN FORSCHUNG E.V., Muenchen (DE); TECHNISCHE UNIVERSITAET DRESDEN, Dresden (DE)

(72) Inventors: Volker FUX, Pirna (DE); Steffan BONSS, Zelle-Mehlis (DE); Marko SEIFERT, Dresden (DE); Andrea BERGER, Dohna (DE); Thomas FIEBIGER, Dresden (DE)

(73) Assignees: FRAUNHOFER-GESELLSCHAFT ZUR FOERDERUNG DER ANGEWANDTEN FORSCHUNG E.V., Muenchen (DE); TECHNISCHE UNIVERSITAET DRESDEN, Dresden (DE)

(21) Appl. No.: 16/092,360

(22) PCT Filed: Apr. 7, 2017
(86) PCT No.: PCT/EP2017/058380

§ 371 Date: Oct. 9, 2018

(30) Foreign Application Priority Data
Apr. 8, 2016 (DE) 10 2016 205 943.2

(51) Int. Cl. B23K 26/00; B23K 26/21; B23K 26/323; B23K 26/34; B23K 20/04

(52) U.S. Cl. CPC B23K 26/0093; B23K 26/21; B23K 2101/34; B23K 26/34; B23K 20/04; B23K 26/323

(57) ABSTRACT

The present invention relates to an apparatus and a method for the adaptive manufacturing of metallic components from a substrate (3) and a supporting element (1) which is to be applied to the substrate (3) and is to be connected in an integrally bonded manner to the substrate (3), with a supply device (7) which is configured to guide the supporting element (1) onto a surface to be coated of the substrate (3), and at least one laser light source (4) with which at least the surface of the supporting element (1) can be preheated directly before or at an impingement point or an impingement region between the supporting element (1) and the substrate (3) to a temperature suitable for the integrally bonded joining by means of an emitted laser beam (6). In addition, a rolling device (2) is provided which is equipped with at least one roll and is configured to press the heated supporting element (1) onto the substrate (3) and, in the process, to connect them in an integrally bonded manner to the substrate (3). The supporting element (1) is applied to the substrate (3) track by track or layer by layer by means of a transverse movement of the substrate (3) relative to the supply device (1) or a movement of the supply device (7), such that individual tracks of the supporting element material are arranged next to one another, or layers of the supporting element material are arranged one above another, on the surface of the substrate (3).

The present invention relates to an apparatus and to a method for manufacturing metallic components.

Metallic components can be connected by means of a plurality of methods which differ in respect of their complexity. A combination of local deformation at a locally realized forming temperature arises in the case of joining methods, such as gas and resistance pressure welding or friction welding, cf. D. Böhme, F.-D. Hermann: Handbuch der Schweißverfahren [Manual of welding methods], part II, DVS-Verlag, Düsseldorf 1992, page 45 et seq and page 269 et seq. For individual metallic strips, laser assisted joining is known, for example, from the document DE 195 02 140 C1 or the document EP 2 090 395 A2.

In the case of large components, such as all types of shaft, rolls and tubular components for various applications, use can be made, for example, of a casting process or the classic metallurgical manufacturing chain, i.e. casting and forging or freeform cutting. In addition to the near net shape shaping, forging especially has the task of reducing and eliminating structural segregations, pores and casting cavities. However, structural refinement and associated improvements in the properties are also achieved by forging. The tools necessary for this purpose constitute a substantial cost factor of the forging process.

Depending on the type of component, further processing often takes place by highly energy-intensive intermediate heating and taking into consideration material-dependent cooling regimes which, for example, in the case of components having a large cross section, may also take several days because of a shrinkage stress limit, cf. K. Lange: Umformtechnik [Forming technology], volume 2: Massivumformung [Solid forming], Springer-Verlag 1993 and D. M. Schibisch, L. de Vathaire: elektrowärme international, February 2013, pages 79-86.

For large and complicated shapes, a multiplicity of intermediate heating operations are often necessary. The heating and cooling of large parts composed of high-alloyed steels during forging and during heat treatment is highly time-intensive. For efficiency reasons, the necessity of combining similar shapes during the forging and similar types of steel during the heat treatment is expedient, and therefore, together with other forging-specific factors, quick preparation of forged parts is frequently difficult.

Thick-walled seamless tubes, in turn, are typically manufactured by means of casting and extrusion, continuous casting, centrifugal casting or reciprocating step methods, cf. K.-H. Brensing, B. Sommer: Herstellverfahren für Stahlrohre [Manufacturing Methods for Steel Tubes], Mannesmannröhren-Werke AG, 45466 Wülhelm a. d. Ruhr. In particular, large components manufactured by means of freeform cutting subsequently require a complicated final machining process. The material of the components or workpieces is selected here not only taking into consideration the loads occurring for the intended use area, but they also have to comply with the respective production methods.

If the basic materials do not satisfy the potential requirements imposed on the components, components can be manufactured from two materials, for example via composite casting technologies, e.g. centrifugal casting for the production of composite cast rolls (cf. M. Winhager, J. Girardi, K. Maier: Walzenguss: Vom Wegwerfprodukt zum umweltschonenden High-Tech-Werkzeug [Roll casting] [from disposable product to environmentally protecting high-technology tool], Gießereirundschau 51 (2004), Issue 5/6, pages 100-103). Since these technologies are too complicated for a series of components and are also not useable for all materials and use areas, the component surfaces most exposed to corrosion or wear are provided with a finishing layer by subsequent coating techniques.

Typical methods for surface finishing include galvanic coating, coating by means of thermal spraying and build-up welding. While galvanic coating (e.g. hard chrome layers) proceeds in the cold state and customarily realizes layer thicknesses of up to <0.1 mm, during thermal spraying (cf. F. Gätner, J. Voyer, Xiumei Qi, H. Kreye: Neue Herausforderungen für das Draht- and Stabflammspritzen [New Challenges for wire and rod flame spraying], Universität der Bundeswehr Hamburg, Germany), with the exception of cold gas spraying, complete to partial fusing of the coating material is sought, with layer thicknesses s of <1 mm customarily being realized. All build-up welding processes, e.g. MIG/MAG, submerged arc welding, plasma and laser methods, are based on the molten state of the layer material and melting of the substrate surface, and therefore, depending on the method and built-up layer thicknesses, powerful heating of the components or component surfaces takes place. The maximum layer thicknesses customarily built up in a single layer are 2-3 mm; in exceptional cases, up to 5 mm are provided. The coating of large component surfaces is likewise highly time-intensive.

Furthermore, the conventional production line includes measures for eliminating scale and dust and for protecting against excessive thermal radiation and noise.

The present invention is therefore based on the object of developing an apparatus and a method, with which cost- and energy-efficient manufacturing of relatively large components is made possible.

This object is achieved according to the invention by an apparatus according to Claim 1 and a method according to Claim 9. Advantageous refinements and developments are described in the dependent claims.

An apparatus for manufacturing metallic components from a substrate and a supporting element which is to be applied to the substrate has a supply device which is configured to guide the supporting element onto a surface to be coated of the substrate. In addition, the apparatus has at least one laser light source which is configured to heat at least the surface of the supporting element to a temperature suitable for the integrally bonded joining directly before and/or at an impingement point or an impingement region between the supporting element and the substrate by means of at least one emitted laser beam. Finally, a rolling device is provided which is equipped with at least one roll and with which the heated supporting element can be pressed onto the substrate and, in the process, an integrally bonded connection is produced. A moving unit and/or the supply device is or are designed to apply the supporting element to the substrate track by track or layer by layer, by means of a transverse movement of the substrate relative to the supply device and/or a movement of the supply device, such that at least one track of the supporting element material is arranged on the surface of the substrate or individual tracks of the supporting element material are arranged next to one another, and/or layers of the supporting element material are arranged one above another, on the surface of the substrate.

With the apparatus described, it is possible in an energy-efficient, force-saving and also space-saving manner to manufacture large-area (2D) components and/or large-volume (3D) components track by track and layer by layer. Said large-volume components or said components having large surfaces composed of one or more firm materials then typically have exclusively a metallic binding between individual layers or tracks. The application and connection of individual tracks or layers or track layers takes place here virtually in a “cold” state, and therefore a predominant portion of the initial structure of the supplied materials is maintained. A reliable connection is produced here by the supporting element being pressed flat onto the substrate. The substrate can be arranged here on a substrate holder, and therefore the individual roll of the rolling device presses the supporting element onto the substrate. Application track by track is intended here to mean in particular also the application of only a single track of the supporting element material onto the substrate. The relative movement between the supply device and the substrate then serves especially for positioning the supporting element on the substrate surface.

Both the substrate and the supporting element are typically formed from a metallic material, but at least the material of the supporting element or the material of the substrate may also be formed from a thermoplastic, preferably in the form of a polymer-matrix composite on the basis of thermoplastic. Steels, nickel and nickel alloys, copper and copper alloys, titanium and titanium alloys, aluminium and aluminium alloys and also various special metals can be used as the materials for the substrate and/or the supporting element. A substrate material and the supporting element material can be identical; however, different materials may also be used for the substrate and the supporting element.

Preferably, both the supporting element and the substrate are heated at the respective surfaces to be connected to the temperature suitable for the integrally bonded joining directly before and/or at the impingement point or an impingement region by the laser beam emitted by the laser light source. This permits an improved connection of the two elements.

It can be provided that the supporting element is strip-shaped or wire-shaped. “Strip-shaped” is intended to be understood here as meaning in particular that a length and a width of the supporting element are significantly greater than a thickness, typically at least five times the thickness. The term “wire-shaped” is intended to be understood as meaning in particular that the length of the supporting element is significantly greater than the thickness thereof and significantly greater than the width thereof. The length is typically at least five times the thickness or the width. The cross section of the wire-shaped supporting element is preferably rectangular, but may also be circular.

The substrate is intended to have a convex surface and to preferably be cylindrical. Alternatively, the substrate can also be configured in a plate-like manner or can have a concave surface. The substrate is typically wider than the supporting element; a width of the substrate is preferably at least twice a width of the supporting element. Alternatively or additionally, the substrate can also be thicker than the supporting element. A thickness of the substrate is preferably at least twice a thickness of the supporting element.

A preheating device can be provided with which the supporting element and/or the substrate can be preheated before the surface to be joined of the supporting element impinges on a surface of the substrate. The preheating device forms at least one laser beam and/or a plasma arc. Alternatively or additionally, the preheating device can also have an induction generator or a device for conductive heating or for heating by means of a TIG arc (tungsten inert-gas arc). With the preheating device, it is possible to better prepare the materials to be joined for the subsequent connecting process since essential process parameters are positively influenced, and therefore the actual joining process can proceed more simply.

The at least one laser beam which is emitted by the laser light source is typically formed linearly or in a rectangular shape in order to heat a wide strip of the material. However, it can also be provided that the at least one laser beam is deflectable one-dimensionally, i.e. is preferably moved in a constant repetition over the region to be heated.

The laser light source, which is also referred to as a laser radiation source, can be formed so as to direct the at least one laser beam emitted by it onto an edge region of a track of the supporting element that is already connected in an integrally bonded manner to the substrate, in order to prepare said edge region for easier application of a further track to be applied next to the track already connected in an integrally bonded manner. The edge region here is intended to be understood as meaning in particular a region having a width of 10 percent, preferably 5 percent, of the width of the entire track.

Alternatively or additionally, a welding device can be provided with which a weld seam can be generated between two tracks of the supporting element that are arranged next to each other. The tracks can thereby be better connected to each other.

It can be provided that pressing by means of the rolling device takes place directly after the heating by means of the laser beam. In a particularly preferred manner, the impingement point or the impingement region is located below the rolling device in order to ensure prompt joining, ideally taking place immediately after the heating by the laser beam, by means of pressing on by means of the rolling device.

A method for manufacturing metallic components from a substrate and a supporting element which is to be applied to the substrate and is to be connected in an integrally bonded manner to the substrate has a plurality of steps. The supporting element is guided by a supply device onto a surface to be coated of the substrate. At least the surface of the supporting element is heated to a temperature suitable for the integrally bonded joining directly before and/or at an impingement point or an impingement region between the supporting element and the substrate by a laser beam emitted by at least one laser light source. The heated supporting element is subsequently pressed onto the substrate by a rolling device and, in the process, connected to the substrate in an integrally bonded manner. The supporting element is applied to the substrate track by track or layer by layer, by means of a transverse movement of the substrate relative to the supply device and/or a movement of the supply device relative to the substrate, such that at least one track of the supporting element material is arranged on the surface of the substrate, or individual tracks of the supporting element material are arranged next to one another, and/or individual layers of the supporting element material are arranged one above another, on the surface of the substrate.

The substrate and the supporting element are preferably connected to each other in a shielding gas atmosphere in order to avoid soiling of the surface and therefore a poorer connection. Both an inert gas and an active gas can be used as the shielding gas.

An overall deformation of the supporting element during the pressing together with the substrate is intended to lie within the range of 1 percent to 50 percent of the initial thickness of the supporting element in order to permit a reliable connection.

The method described is preferably carried out with the apparatus described, or the apparatus described is typically suitable for carrying out the explained method.

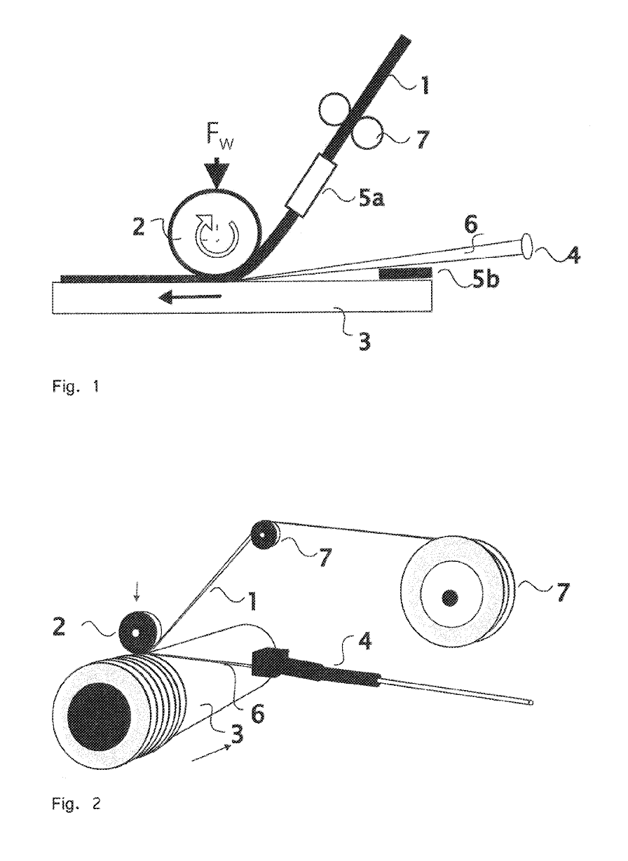

Exemplary embodiments of the invention are illustrated in the drawings and will be explained below with reference to FIGS. 1 to 6.

In the drawings:

FIG. 1 shows a lateral schematic view of an apparatus for adaptive manufacturing of metallic components and component surfaces;

FIG. 2 shows a perspective view of the apparatus with a cylindrical substrate;

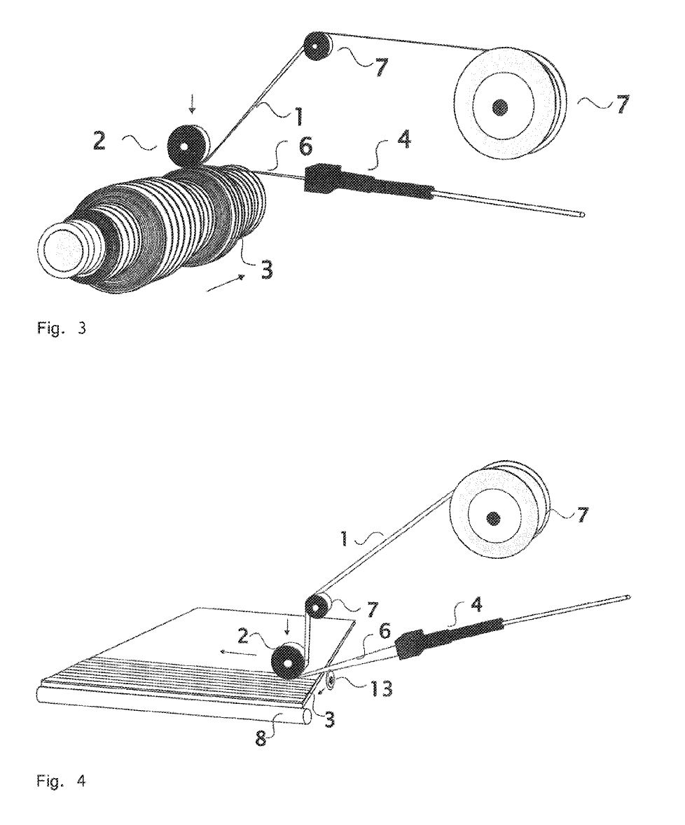

FIG. 3 shows a view corresponding to FIG. 2 with a plurality of layers applied to the substrate;

FIG. 4 shows a perspective view of the apparatus with a plate-like substrate;

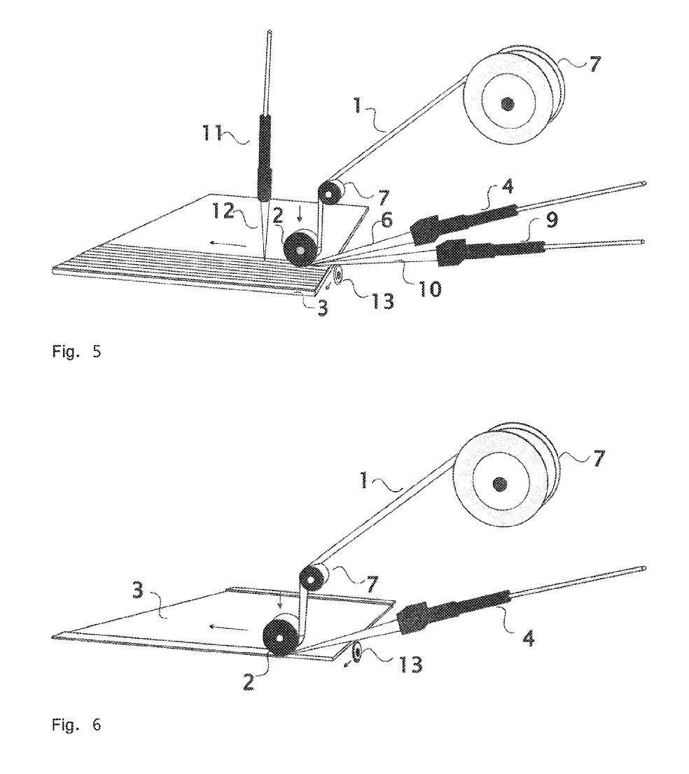

FIG. 5 shows a view corresponding to FIG. 4 with a welding device, and

FIG. 6 shows a view corresponding to FIG. 4 with a composite sheet.

FIG. 1 illustrates an apparatus for adaptive manufacturing of metallic components in a schematic lateral view. A supporting element 1, in the exemplary embodiment illustrated a strip composed of an NiCr alloy, is guided onto a substrate 3 by a supply device 7 formed in the exemplary embodiment illustrated by two rollers. In the exemplary embodiment illustrated, the substrate 3 is plate-like and formed from a low-alloyed steel.

By means of the apparatus shown and the method described below, a component volume, i.e. a volume of a component formed from the substrate 3 and the supporting element 1, is built up, starting from the substrate 3 as the basic body, track by track and/or layer by layer by means of the strip-shaped supporting element 1 as the building-up material. In further exemplary embodiments, the supporting element 1 can also be wire-shaped.

The supporting element 1 is guided for this purpose, as already described, at an angle onto a surface of the substrate 3 via an individual press-on roller or roll 2 and rolled on with a force F_{W} which is preferably formed in a manner acting perpendicularly to a substrate surface. Directly before the rolling on, a rectangular or linear laser beam 6, which is emitted by a laser radiation source or laser light source 4, heats the two later contact surfaces of the substrate 3 and of the supporting element 1 to suitable joining temperatures at an impingement point or in an impingement region which is also referred to as the laser contact zone. The laser beam 6 here is somewhat wider than the supplied supporting element 1, i.e. a width of the laser beam 6 exceeds a width of the supporting element 1 by, for example, 5 percent. In the exemplary embodiment illustrated, a thickness of the supporting element 1 after the rolling on is still 90 percent of its initial thickness.

During the rolling on, essentially only the two heated surface regions are deformed by the acting rolling force and thereby fixedly connected to each other. By means of a transverse movement, which is coordinated with a wire width or strip width of the supporting element 1, or, in the case of a cylindrical or rotationally symmetrical substrate 3, is coordinated with a rotation of the substrate 3, a track by track or spiral single-layered (n=1) surface build-up takes place. After a first track or first layer is completed, the next track or layer (n=2) can be deposited in a continuous sequence by reversal of the transverse movement. This can take place until a specified contour n=x is achieved. However, the tracks or layers applied after the first track or the first layer can also be formed beginning again from the initial point of the original first track or first layer even after the supporting element 1 has been severed. This also gives rise to the possibility of using materials which differ track by track or layer by layer and/or different strip and/or wire geometries.

In the exemplary embodiment shown in FIG. 1, a first preheating device 5a in the form of an inductor is additionally provided, by means of which the supporting element 1 is guided before impinging on the substrate 3 and which preheats the supporting element 1. A second preheating device 5b is arranged above the substrate 3, but below the laser beam 6, and heats the substrate 3 by means of a further inductor. By means of the preheating, the respective temperature and deformation gradients can be positively influenced or varied. At the same time, coupling of the laser beam 6 into a gap in the impingement region is improved, and also higher process speeds can be realized. In further exemplary embodiments, the substrate 3 can also be arranged on a substrate holder and guided on the holder by the rolling device 2. In addition, depending on the materials to be joined of the substrate 3 and of the supporting element 1, in order to protect against oxidation a shielding gas atmosphere can be provided, in which the substrate 3 and the supporting element 1 are located during the connection. The supporting element 1 and the substrate 3 are typically preheated directly before the supporting element 1 is connected to the substrate 3.

FIG. 2 shows, in a perspective view, a further exemplary embodiment of the apparatus and of the method with a cylindrical substrate 3. Recurring features are provided with identical reference signs in this figure and also in the following figures. The supply device 7 merely has a deflecting roller and a supply roller. The supporting element 1 is wound up on the supply roller and is unwound from there and guided to the substrate 3 via the supply roller. By means of the cylindrical design 3, the substrate 3 now serves as a type of second roll of a pair of rolls formed with the roll 2.

For the manufacturing of the components, after the possibly necessary severing of the wire or strip forming the supporting element 1 and an optional change in the material or a geometry of the supporting element 1, local build-up of the volume can be undertaken (see FIG. 3). In the case of narrow contour changes, the build-up of the volume can also take place without a transverse movement in accordance with the specified strip or wire width up to the specified layer number n=x.

A further embodiment, in which the supporting element 1 is now applied layer by layer to tracks and layers which have already been applied is illustrated in FIG. 3 in a view corresponding to FIG. 2. During corresponding manufacturing of three-dimensional components from the substrate 3 and the supporting element 1, a plurality of advantages arise in comparison to conventional metallurgical manufacturing steps: a greatly shortened manufacturing run is achieved, in which only low tool costs and low energy costs occur. Overall, only low forming forces are necessary, thus giving rise to small room sizes for the plant technology. In addition, exacting requirements do not need to be imposed on foundations and manufacturing halls, as forging presses or similar require. In addition, scale formation and releasing of dust or particles are avoided, and heating and holding furnaces can be dispensed with. A highly efficient automatic processing chain is therefore produced.

With regard to the components, only very low heating-through temperatures are required, which results in low thermal radiation. This leads to improved handling of the components since only small waiting times, if any at all, occur between the generation of the component and a final machining process. In addition, it is possible to avoid in a simple manner structural segregations and coarse-grained structures and to achieve very low shrinkages and shrinkage stresses. This leads, also in conjunction with the advantage of an easily achievable combination of various materials, to efficient production of variable components having the desired properties and with high near net shape accuracy.

FIG. 4 illustrates, in a perspective view, a substrate 3 which is of flat design in the form of a plate, to which the supporting element is applied. While, in the case of the method shown in FIGS. 2 and 3 and the apparatus shown there, the substrate 3 is typically guided relative to the stationary supply device 7 in a transverse movement, in the case of the exemplary embodiment shown in FIG. 4 said transverse movement is achieved by one or more linear axes via a moving unit 8 arranged below the substrate 3. Alternatively or additionally, the transverse movement can also be undertaken by the supply device 7. In addition, a detaching unit 13 in the form of flying shears or a cutting-off wheel is arranged below the substrate 3. With this apparatus, it is possible to carry out a coating in the form of an applied track first of all in one direction, then to detach the supporting element 1 by means of the detaching unit 13 and, with a corresponding track offset, to realize a further track next to the track already applied to the substrate 3.

In the case of such a flat use of the method, advantages likewise arise in respect of the process, such as avoiding a molten initial state and, because of the low heat-through temperatures which can be achieved, only very low shrinkage stresses, if any at all. On the contrary, a partial combining of shrinkages is still possible by means of the deformation operation. In comparison to build-up welding methods, only a low energy requirement is necessary for the building up of the layers, and therefore significantly higher manufacturing speeds can be achieved with the manufacturing times being substantially shorter. In addition, in turn, dust- and particle-free manufacturing in the final contour or very near net shape is possible with virtually complete use of the material.

With regard to the components produced, in comparison to galvanic methods or thermal spraying a reliable and fixed metallic binding arises between the substrate 3 as basic body and the supporting element 1 as supporting layer which typically consists predominantly of a high-quality worked structure, i.e. only has low structural segregations, if any at all. Even in the case of small thicknesses of the supporting element 1 of less than 1 mm, the desired chemical composition is reliably ensured. In comparison to build-up welding, there is only a minimal, or if any, occurrence of molten states in the region of the material transitions, i.e. there is also no dilution by the substrate material into the remaining cross section.

The further machining process can take place immediately afterwards, in particular during component manufacturing without preheating, but in principle even parallel to the component manufacturing.

In the case of the apparatus likewise shown in a perspective view in FIG. 5, use is now also made of a further, second laser light source 9 which emits a second laser beam 10. Said second laser beam 10 serves for preheating the substrate 3. In addition, a welding device 11 is provided above the substrate 3. The welding device 11 can emit a welding laser beam 12 or a tungsten inert-gas or plasma arc.

The welding laser beam 12 connects tracks lying next to one another of the supporting element 1 to one another by means of a laser weld seam in the form of an I joint. As illustrated in FIG. 5, the weld seam can be formed parallel to the depositing of the supporting element 1 or can take place with the same apparatus in a subsequent method step.

In the exemplary embodiment illustrated, the width of the first laser beam 6 emitted by the first laser light source 4 and directed onto the impingement region can be set in such a manner that even an edge of a layer already applied or of a track already applied of the supporting element 1 is also heated by the laser beam 6. For this purpose, both static and dynamic beam shaping can be used.

The roll 2 used for applying and pressing on the supporting element 1 can have a lateral guide on one side which is preferably arranged on a side facing away from the coated surface, in order to ensure a lateral pressure for connection to the neighbouring track or neighbouring layer.

In addition to full-surface coatings or volume structures, the method described is also suitable for partial application of strip- or wire-shaped materials to flat or rotationally symmetrical components, e.g. for the manufacturing of composite sheets or composite boards, as illustrated in FIG. 6. In the exemplary embodiment illustrated in this figure, only one individual track of the supporting element material is positioned on the substrate 3 by a relative movement, which is brought about by the moving unit 8, between the supply device 7 and the substrate 3, and is connected to the substrate 3 by the rolling device 2 and the laser beam 6. This individual track of the supporting material can be applied either flush with the outer edges of the substrate 3 (for example a sheet), or it is applied in such a manner that it is connected in an only partially overlapping manner to the edges of the substrate 3 (or of the substrates 3). Such components produced in this manner are suitable for realizing readily joinable lightweight structures, for example for the combination of aluminium alloys (sheet) and steel (support). Only features of the various embodiments that are disclosed in the exemplary embodiments can be combined with one another and individually claimed.

With reference to the exemplary embodiment below, the extremely high economic efficiency of the method described and of the apparatus described will be illustrated: if a steel strip having a width of 20 mm and a thickness of 3 mm is used for the application, i.e. as the supporting element 1, at an advancing speed of 10 m/min an application rate of 280 kg/h or an area output of 12 m²/h arises. These figures can currently not be approximately achieved even with high-performance coating methods. At the same time, the energy input is much lower than for build-up welding. Since the advancing speeds which can be achieved with the laser roll-bonding described are dependent on the power of the laser light source 4 used and on the materials to be processed, advancing speeds of 20 m/min or higher can be achieved, for example, in the event of a combination between steels and nickel alloys, when suitable laser light sources 4 are used. The total heat input is still lower at increasing speed.

In the case of a coating, which is selected as a comparison example, of thick-walled tubes for corrosion protection by means of laser powder build-up welding, the advancing speed is approx. 1.8 m/min, with an individual track width of 8 mm and an individual track height of 1.5 mm at a laser power of 8 kW. In order to realize layer heights which are as uniform as possible, overlapping rates with neighbouring tracks of 50 percent customarily have to be selected. For an increase in surface, this means an actual track width of 4 mm. In order to coat a tube having an outside diameter of 400 mm and a length of 18 m, a coating time of 52.5 h therefore arises. If, with the method described, a strip (of a width of 10 mm, a thickness of 1.7 mm, and a thickness of 1.5 mm after the application) is coated at an advancing speed of 6 m/min, with a laser power of only 4 kW being required and track overlapping being omitted because of the geometry, without preheating of strip and/or substrate surface a coating time of 6.3 h arises. When a strip of a width of 20 mm is used, even only 3.15 h is required for a laser power of 8 kW. At the same time, no metal dust arises, 100 percent of the material is used and the surface requires only little subsequent processing, if any at all, because of being formed by smooth rolls. In addition, the heating through the tube turns out to be significantly lower in comparison to build-up welding.

If the process described is also assisted by the preheating, coating speeds of greater than or equal to 10 m/min are realistic. At a value of the advancing speed of 10 m/min, a coating time of 3.8 h arises for a strip width of 10 mm, or of 1.9 h for a strip width of 20 mm. Depending on the preheating level, although the heating through temperature of the tube is also increased, it remains below the temperature arising during build-up welding.

1. Apparatus for manufacturing metallic components from a substrate (3) and a supporting element (1) which is to be applied to the substrate (3) and is to be connected to the substrate (3) in an integrally bonded manner,
with a supply device (7) which is configured to guide the supporting element (1) onto a surface to be coated of the substrate (3),
at least one laser light source (4) which is configured to heat at least the surface of the supporting element (1) directly before and/or at an impingement point or an impingement region between the supporting element (1) and the substrate (3) to a temperature suitable for the integrally bonded joining by means of at least one emitted laser beam (6), and
a rolling device (2) which is equipped with at least one roll and is configured to press the heated supporting element (1) onto the substrate (3) and, in the process, to connect them to the substrate (3) in an integrally bonded manner, wherein
a moving unit (8) and/or the supply device (7) is designed to apply the supporting element (1) to the substrate (3) track by track or layer by layer, by means of a transverse movement of the substrate (3) relative to the supply device (1) and/or a movement of the supply device (7), such that at least one track of the supporting element material is arranged on the surface of the substrate (3), or individual tracks of the supporting element material are arranged next to one another, and/or layers of the supporting element material are arranged one above another, on the surface of the substrate (3).

2. Apparatus according to claim 1, characterized in that the supporting element (1) is strip-shaped or wire-shaped.

3. Apparatus according to claim 1 or claim 2, characterized in that the substrate (3) has a convex surface or is plate-like.

4. Apparatus according to claim 1, characterized in that a preheating device (5a, 5b) is provided with which the supporting element (1) and/or the substrate (3) can be preheated before the surface to be joined of the supporting element (1) impinges on a surface of the substrate (3), wherein the preheating device (5a, 5b) forms at least one laser beam, a tungsten inert-gas arc and/or a plasma arc and/or has at least one induction generator.

5. Apparatus according to claim 1, characterized in that the at least one laser beam (6) is formed linearly or in a rectangular shape.

6. Apparatus according to claim 1, characterized in that the laser light source (4) is formed so as to direct the at least one laser beam (6) onto an edge region of a track of the supporting element (1) that is already connected in an integrally bonded manner to the substrate (3).

7. Apparatus according to claim 1, characterized in that a welding device (11) is provided with which a weld seam can be generated between two tracks arranged next to each other of the supporting element (1).

8. Apparatus according to claim 1, characterized in that a thickness of the substrate (3) is greater than a thickness of the supporting element (1).

9. Method for manufacturing metallic components from a substrate (3) and a supporting element (1) which is to be applied to the substrate (3) and is to be connected in an integrally bonded manner to the substrate (3), in which
the supporting element (1) is guided by a supply device (7) onto a surface to be coated of the substrate (3),
at least the surface of the supporting element (1) is heated directly before and/or at an impingement point or an impingement region between the supporting element (1) and the substrate (3) to a temperature suitable for the integrally bonded joining by means of a laser beam (6) emitted by at least one laser light source (4), and
the heated supporting element (1) is pressed onto the substrate (3) by a rolling device (2) and, in the process, is connected in an integrally bonded manner to the substrate (3), where
the supporting element (1) is applied to the substrate (3) track by track or layer by layer by means of a transverse movement of the substrate (3) relative to the supply device (1) and/or a movement of the supply device (7) relative to the substrate (3), such that at least one track of the supporting element material is arranged on the surface of the substrate (3), or
individual tracks of the supporting element material are arranged next to one another, and/or individual layers of the supporting element material are arranged one above another, on the surface of the substrate (3).

10. Method according to claim 9, characterized in that the substrate (3) and the supporting element (1) are connected to each other in an inert gas atmosphere.

11. Method according to claim 9, characterized in that an overall deformation of the supporting element (1) during the pressing-together operation is kept within the range of 1 percent to 50 percent of the initial thickness of the supporting element (1).
